(19) United States
(12) Patent Application Publication
(10) Pub. No.: US 2022/0090252 A1
(43) Pub. Date: Mar. 24, 2022

(54) METHODS OF MANUFACTURING STRUCTURES FROM OXIDE DISPERSION STRENGTHENED (ODS) MATERIALS, AND ASSOCIATED SYSTEMS AND DEVICES

(71) Applicant: NuScale Power, LLC, Portland, OR (US)

(72) Inventors: Derick Botha, Corvallis, OR (US); Michele Walden, Albany, OR (US)

(21) Appl. No.: 17/479,932

(22) Filed: Sep. 20, 2021

Related U.S. Application Data
(60) Provisional application No. 63/080,571, filed on Sep. 18, 2020.

(51) Int. Cl. C23C 6/00; G21D 1/02; G21D 9/00

(52) U.S. Cl. CPC C23C 6/00; G21D 9/00; G21D 1/02

(57) ABSTRACT

Method of fabricating structures, such as parts for use in nuclear power generation systems, are described herein. A representative method of fabricating a part for a nuclear reactor system includes additively manufacturing the part as a monolithic structure from a wire formed of an oxide dispersion strengthen (ODS) material, which includes an oxide material dispersed within a metal material. Specifically, the method can include directing a beam of thermal energy toward the wire to melt the wire, and permitting the melted wire to cool and solidify to form the part such that the oxide material remains substantially dispersed within the metal material. By maintaining the dispersion of the oxide material within the metal material, the ODS material can retain a good creep resistance, wear-resistance, corrosion resistance, and/or other ODS material property at elevated temperatures—even after fabrication.

### CROSS-REFERENCE TO RELATED APPLICATION

This application claims the benefit of U.S. Provisional Patent Application No. 63/080,571, filed Sep. 18, 2020, and titled “OXIDE DISPERSION STRENGTHENED (ODS) MATERIAL FABRICATION WITH WIRE USING DIRECTED ENERGY DEPOSITION (DED) LASER PRINTING, AND ASSOCIATED SYSTEMS AND DEVICES,” which is incorporated herein by reference in its entirety.

### TECHNICAL FIELD

The present technology is related to methods of manufacturing structures, such as parts for use in nuclear reactor systems, from oxide dispersion strengthened (ODS) materials.

### BACKGROUND

Oxide dispersion strengthened (ODS) materials (e.g., alloys) consist of a metal matrix with small oxide particles dispersed within the matrix. ODS materials exhibit good corrosion resistance and mechanical properties at elevated temperatures. Likewise, these materials exhibit good creep resistance as the oxide particles decrease movement of dislocations within the metal matrix.

ODS materials are typically fabricated by ball milling two powders (e.g., a metal powder and an oxide powder) and then compacting the powders into an ingot or similar shape using a powder metallurgy process, such as a hot isostatic pressing (HIP) process. The compacted material is then cold worked or hot worked to give the material a fine-grained structure with increased creep resistance. Finally, the ODS material can be shaped into a desired geometry by cold pressing or other processes that preserve the ODS matrix structure.

However, such an ODS material fabrication process limits the geometry of structures that can be manufactured with the ODS material. For example, heating the ODS material during shaping, or welding multiple parts of ODS material together to form a more complex part, can cause the oxide to come out of solution from the metal material such that the oxide material is less dispersed through the metal matrix, thereby degrading the ODS material properties of the structure. More specifically, heating ODS materials to their recrystallization temperature can change the structure and base mechanical properties of the ODS material, while the oxide dispersion changes with melting and cooling.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIG. 1 is a partially schematic, partially cross-sectional view of a nuclear reactor system configured in accordance with embodiments of the present technology.

FIG. 2 is a partially schematic, partially cross-sectional view of a nuclear reactor system configured in accordance with additional embodiments of the present technology.

FIG. 3 is a flow diagram of a process or method for fabricating a structure—such as one or more components of the nuclear reactor systems of FIG. 1 and/or FIG. 2—in accordance with embodiments of the present technology.

FIG. 4 is a cross-sectional side view of an additive manufacturing system configured in accordance with embodiments of the present technology.

FIG. 5 is an isometric view of an exemplary part or structure that can be fabricated using the method of FIG. 3 in accordance with embodiments of the present technology.

### DETAILED DESCRIPTION

Aspects of the present disclosure are directed generally toward methods of manufacturing structures, such as parts for use in nuclear power generation systems, and associated systems and devices. In several of the embodiments described below, for example, a method of fabricating a part for a nuclear reactor system includes additively manufacturing the part as a monolithic structure from a wire formed of an oxide dispersion strengthen (ODS) material, which includes an oxide material dispersed within a metal material. Specifically, the method can include directing a beam of thermal energy toward the wire to melt the wire, and permitting the melted wire to cool and solidify to form the part such that the oxide material remains substantially dispersed within the metal material.

In some aspects of the present technology, by maintaining the dispersion of the oxide particles within the metal material, the ODS material can retain a good creep resistance, wear-resistance, corrosion resistance, and/or other ODS material property at elevated temperatures—even after fabrication. Moreover, the additive manufacturing method can be used to form parts having complex geometries that cannot be fabricated with conventional manufacturing processes used to form structures of ODS material while also maintaining the properties of the ODS material.

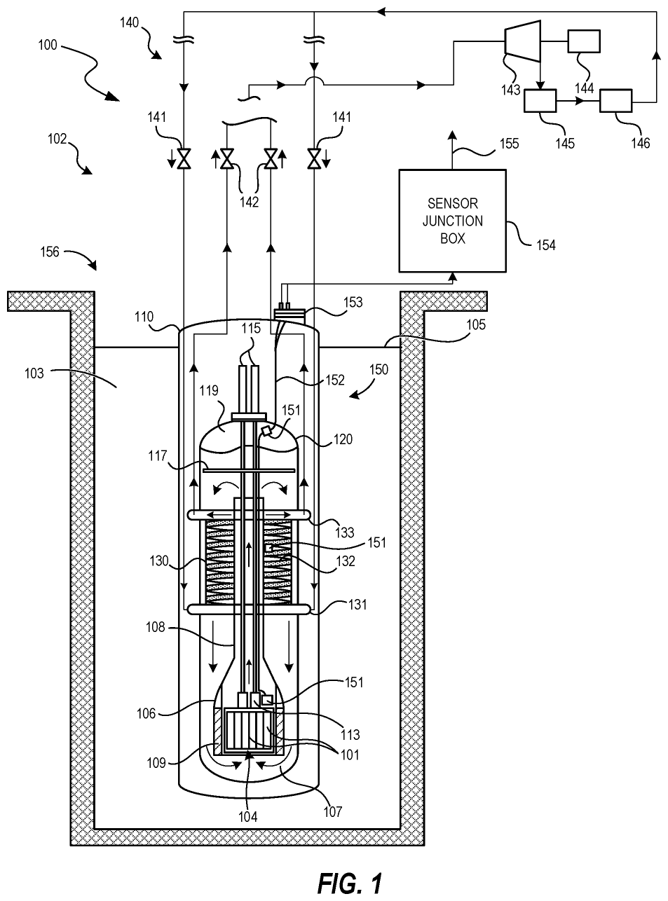

Certain details are set forth in the following description and in FIGS. 1-5 to provide a thorough understanding of various embodiments of the present technology. In other instances, well-known structures, materials, operations, and/or systems often associated with nuclear reactors, additive manufacturing processes, oxide dispersion strengthened (ODS) materials and related fabrication, and the like, are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth. The terminology used below is to be interpreted in its broadest reasonable manner, even though it is being used in conjunction with a detailed description of certain examples of embodiments of the technology.

The accompanying Figures depict embodiments of the present technology and are not intended limit its scope unless expressly indicated. The sizes of various depicted elements are not necessarily drawn to scale, and these various elements may be enlarged to improve legibility. Component details may be abstracted in the Figures to exclude details such as position of components and certain precise connections between such components when such details are unnecessary for a complete understanding of how to make and use the present technology. Many of the details, dimensions, angles and other features shown in the Figures are merely illustrative of particular embodiments of the disclosure. Accordingly, other embodiments can have other details, dimensions, angles and features without departing from the present technology. In addition, those of ordinary skill in the art will appreciate that further embodiments of the present technology can be practiced without several of the details described below.

FIG. 1 is a partially schematic, partially cross-sectional view of a nuclear reactor system 100 configured in accordance with embodiments of the present technology. The system 100 can include a power module 102 having a reactor core 104 in which a controlled nuclear reaction takes place. Accordingly, the reactor core 104 can include one or more fuel assemblies 101. The fuel assemblies 101 can include fissile and/or other suitable materials. Heat from the reaction generates steam at a steam generator 130, which directs the steam to a power conversion system 140. The power conversion system 140 generates electrical power, and/or provides other useful outputs. A sensor system 150 is used to monitor the operation of the power module 102 and/or other system components. The data obtained from the sensor system 150 can be used in real time to control the power module 102, and/or can be used to update the design of the power module 102 and/or other system components.

The power module 102 includes a containment vessel 110 (e.g., a radiation shield vessel, or a radiation shield container) that houses/encloses a reactor vessel 120 (e.g., a reactor pressure vessel, or a reactor pressure container), which in turn houses the reactor core 104. The containment vessel 110 can be housed in a power module bay 156. The power module bay 156 can contain a cooling pool 103 filled with water and/or another suitable cooling liquid. The bulk of the power module 102 can be positioned below a surface 105 of the cooling pool 103. Accordingly, the cooling pool 103 can operate as a thermal sink, for example, in the event of a system malfunction.

A volume between the reactor vessel 120 and the containment vessel 110 can be partially or completely evacuated to reduce heat transfer from the reactor vessel 120 to the surrounding environment (e.g., to the cooling pool 103). However, in other embodiments the volume between the reactor vessel 120 and the containment vessel 110 can be at least partially filled with a gas and/or a liquid that increases heat transfer between the reactor vessel 120 and the containment vessel 110.

Within the reactor vessel 120, a primary coolant 107 conveys heat from the reactor core 104 to the steam generator 130. For example, as illustrated by arrows located within the reactor vessel 120, the primary coolant 107 is heated at the reactor core 104 toward the bottom of the reactor vessel 120. The heated primary coolant 107 (e.g., water with or without additives) rises from the reactor core 104 through a core shroud 106 and to a riser tube 108. The hot, buoyant primary coolant 107 continues to rise through the riser tube 108, then exits the riser tube 108 and passes downwardly through the steam generator 130. The steam generator 130 includes a multitude of conduits 132 that are arranged circumferentially around the riser tube 108, for example, in a helical pattern, as is shown schematically in FIG. 1. The descending primary coolant 107 transfers heat to a secondary coolant (e.g., water) within the conduits 132, and descends to the bottom of the reactor vessel 120 where the cycle begins again. The cycle can be driven by the changes in the buoyancy of the primary coolant 107, thus reducing or eliminating the need for pumps to move the primary coolant 107.

The steam generator 130 can include a feedwater header 131 at which the incoming secondary coolant enters the steam generator conduits 132. The secondary coolant rises through the conduits 132, converts to vapor (e.g., steam), and is collected at a steam header 133. The steam exits the steam header 133 and is directed to the power conversion system 140.

The power conversion system 140 can include one or more steam valves 142 that regulate the passage of high pressure, high temperature steam from the steam generator 130 to a steam turbine 143. The steam turbine 143 converts the thermal energy of the steam to electricity via a generator 144. The low-pressure steam exiting the turbine 143 is condensed at a condenser 145, and then directed (e.g., via a pump 146) to one or more feedwater valves 141. The feedwater valves 141 control the rate at which the feedwater re-enters the steam generator 130 via the feedwater header 131.

The power module 102 includes multiple control systems and associated sensors. For example, the power module 102 can include a hollow cylindrical reflector 109 that directs neutrons back into the reactor core 104 to further the nuclear reaction taking place therein. Control rods 113 are used to modulate the nuclear reaction, and are driven via fuel rod drivers 115. The pressure within the reactor vessel 120 can be controlled via a pressurizer plate 117 (which can also serve to direct the primary coolant 107 downwardly through the steam generator 130) by controlling the pressure in a pressurizing volume 119 positioned above the pressurizer plate 117.

The sensor system 150 can include one or more sensors 151 positioned at a variety of locations within the power module 102 and/or elsewhere, for example, to identify operating parameter values and/or changes in parameter values. The data collected by the sensor system 150 can then be used to control the operation of the system 100, and/or to generate design changes for the system 100. For sensors positioned within the containment vessel 110, a sensor link 152 directs data from the sensors to a flange 153 (at which the sensor link 152 exits the containment vessel 110) and directs data to a sensor junction box 154. From there, the sensor data can be routed to one or more controllers and/or other data systems via a data bus 155.

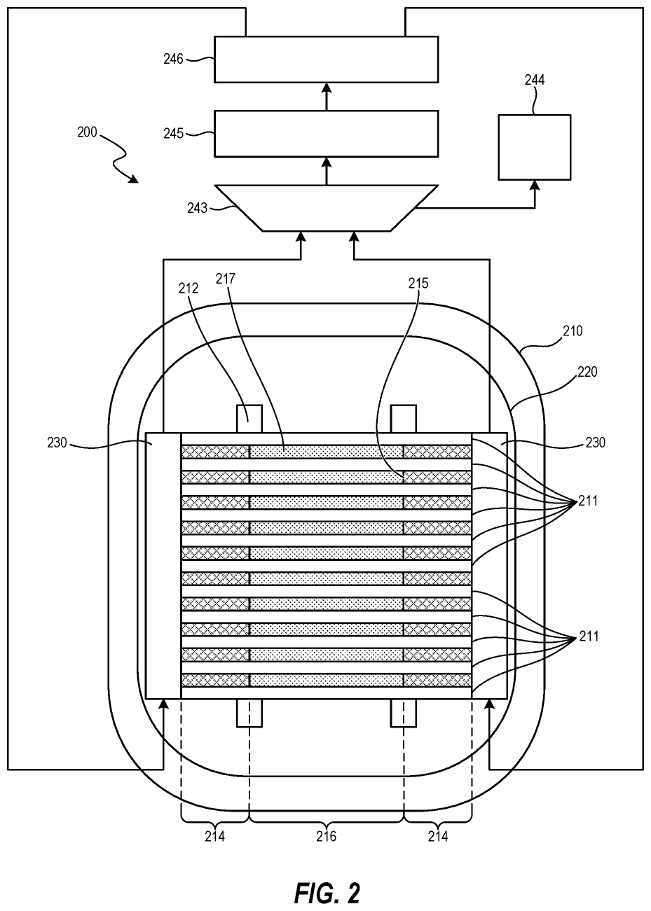

FIG. 2 is a partially schematic, partially cross-sectional view of a nuclear reactor system 200 (“system 200”) configured in accordance with additional embodiments of the present technology. In some embodiments, the system 200 can include some features that are at least generally similar in structure and function, or identical in structure and function, to the corresponding features of the system 100 described in detail above with reference to FIG. 1, and can operate in a generally similar or identical manner to the system 100.

In the illustrated embodiment, the system 200 includes a reactor vessel 220 and a containment vessel 210 surrounding/enclosing the reactor vessel 220. In some embodiments, the reactor vessel 220 and the containment vessel 210 can be roughly cylinder-shaped or capsule-shaped. The system 200 further includes a plurality of heat pipe layers 211 within the reactor vessel 220. In the illustrated embodiment, the heat pipe layers 211 are spaced apart from and stacked over one another. In some embodiments, the heat pipe layers 211 can be mounted/secured to a common frame 212, a portion of the reactor vessel 220 (e.g., a wall thereof), and/or other suitable structures within the reactor vessel 220. In other embodiments, the heat pipe layers 211 can be directly stacked on top of one another such that each of the heat pipe layers 211 supports and/or is supported by one or more of the other ones of the heat pipe layers 211.

In the illustrated embodiment, the system 200 further includes a shield or reflector region 214 at least partially surrounding a core region 216. The heat pipes layers 211 can be circular, rectilinear, polygonal, and/or can have other shapes, such that the core region 216 has a corresponding three-dimensional shape (e.g., cylindrical, spherical). In some embodiments, the core region 216 is separated from the reflector region 214 by a core barrier 215, such as a metal wall. The core region 216 can include one or more fuel sources, such as fissile material, for heating the heat pipes layers 211. The reflector region 214 can include one or more materials configured to contain/reflect products generated by burning the fuel in the core region 216 during operation of the system 200. For example, the reflector region 214 can include a liquid or solid material configured to reflect neutrons and/or other fission products radially inward toward the core region 216. In some embodiments, the reflector region 214 can entirely surround the core region 216. In other embodiments, the reflector region 214 may only partially surround the core region 216. In some embodiments, the core region 216 can include a control material 217, such as a moderator and/or coolant. The control material 217 can at least partially surround the heat pipe layers 211 in the core region 216 and can transfer heat therebetween.

In the illustrated embodiment, the system 200 further includes at least one heat exchanger 230 (e.g., a steam generator) positioned around the heat pipe layers 211. The heat pipe layers 211 can extend from the core region 216 and at least partially into the reflector region 214, and are thermally coupled to the heat exchanger 230. In some embodiments, the heat exchanger 230 can be positioned outside of or partially within the reflector region 214. The heat pipe layers 211 provide a heat transfer path from the core region 216 to the heat exchanger 230. For example, the heat pipe layers 211 can each include an array of heat pipes that provide a heat transfer path from the core region 216 to the heat exchanger 230. When the system 200 operates, the fuel in the core region 216 can heat and vaporize a fluid within the heat pipes in the heat pipe layers 211, and the fluid can carry the heat to the heat exchanger 230.

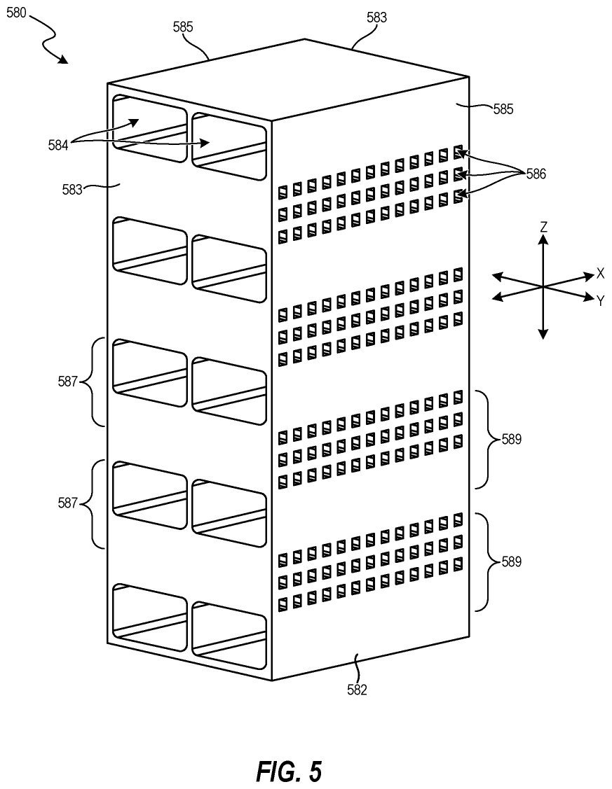

In some embodiments, the heat exchanger 230 can be similar to the steam generator 130 of FIG. 1 and, for example, can include one or more helically-coiled tubes that wrap around the heat pipe layers 211. The tubes of the heat exchanger 230 can include or carry a working fluid (e.g., a coolant such as water or another fluid) that carries the heat from the heat pipe layers 211 out of the reactor vessel 220 and the containment vessel 210 for use in generating electricity, steam, and/or the like. For example, in the illustrated embodiment the heat exchanger 230 is operably coupled to a turbine 243, a generator 244, a condenser 245, and a pump 246. As the working fluid within the heat exchanger 230 increases in temperature, the working fluid may begin to boil and vaporize. The vaporized working fluid (e.g., steam) may be used to drive the turbine 243 to convert the thermal potential energy of the working fluid into electrical energy via the generator 244. The condenser 245 can condense the working fluid after it passes through the turbine 243, and the pump 246 can direct the working fluid back to the heat exchanger 230 where it can begin another thermal cycle. In other embodiments, the heat exchanger can include some features generally similar or identical to the heat exchanger illustrated in FIG. 5.

In some embodiments, the nuclear reactor systems 100 and/or 200 can include some features that are at least generally similar in structure and function, or identical in structure and function, to any of the nuclear reactor systems described in (i) U.S. patent application Ser. No. 17/071,838, titled “HEAT PIPE NETWORKS FOR HEAT REMOVAL, SUCH AS HEAT REMOVAL FROM NUCLEAR REACTORS, AND ASSOCIATED SYSTEMS AND METHODS,” and filed Oct. 15, 2020, (ii) U.S. patent application Ser. No. 17/071,795, titled “NUCLEAR REACTORS HAVING LIQUID METAL ALLOY FUELS AND/OR MODERATORS,” and filed Oct. 15, 2020, and/or (iii) U.S. patent application Ser. No. 17/404,607, titled “THERMAL POWER CONVERSION SYSTEMS INCLUDING HEAT PIPES AND PHOTOVOLTAIC CELLS,” and filed Aug. 17, 2021, each of which is incorporated herein by reference in its entirety.

Referring to FIGS. 1 and 2 together, many of the components of the nuclear reactor systems 100 and 200 can be subject to high temperatures and/or pressures during operation. Accordingly, in some embodiments it can be beneficial to manufacture some or all of the components from oxide dispersion strengthened (ODS) materials (e.g., alloys which consist of a metal matrix with small oxide particles dispersed within the matrix), which exhibit good corrosion resistance, mechanical properties, and creep resistance at high temperature.

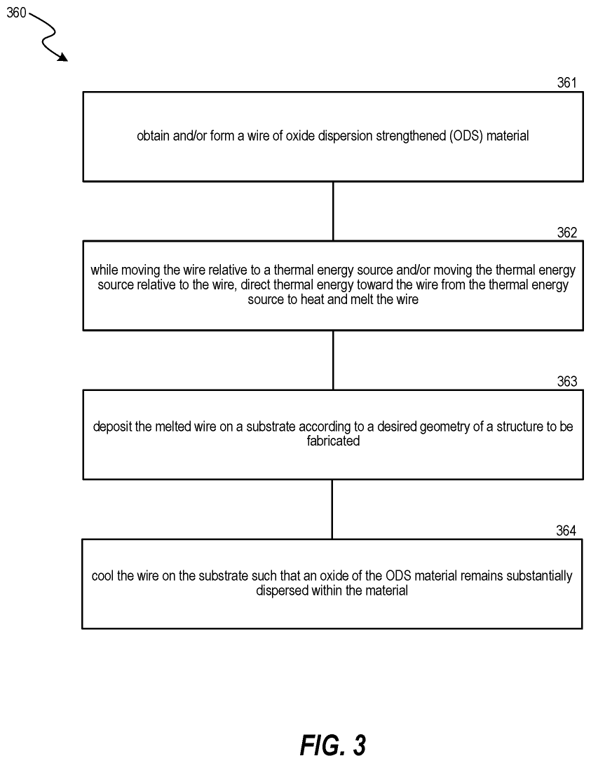

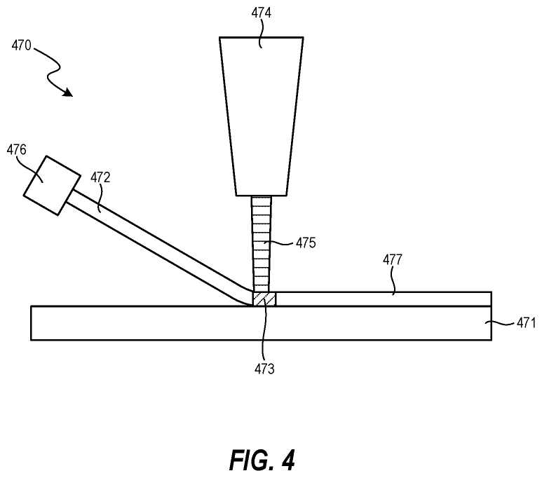

FIG. 3, for example, is a flow diagram of a process or method 360 for fabricating a desired structure—such as one or more components of the nuclear reactor systems 100 or 200—in accordance with embodiments of the present technology. In some embodiments, the method 360 can at least partially comprise an additive manufacturing process employing a wire of ODS material as a feed or build-up material. FIG. 4, for example, is cross-sectional side view of an additive manufacturing system 470 that can be used to at least partially carry out the method 360 in accordance with embodiments of the present technology. Although some aspects of the method 360 are described in the context of the system 470 for illustration, one of ordinary skill in the art will appreciate that the method 360 can be carried out using other suitable systems, such as other additive manufacturing systems.

Referring first to FIG. 4, the system 470 can be a three-dimensional (3D) directed energy deposition (DED) manufacturing system (e.g., a laser metal DED system) configured to “print” a wire 472 of ODS material into the desired structure (e.g., a part of a nuclear reactor system). For example, in the illustrated embodiment the system 470 includes a thermal energy source 474 configured to direct a beam of the thermal energy 475 toward the wire 472 to selectively heat and melt the wire 472, which can be deposited on a substrate 471 in melted form. The beam of thermal energy 475 can be a laser, electron beam, and/or another type of thermal energy generated by the thermal energy source 474. The system 470 can further include a feed mechanism 476 configured to advance the wire 472 toward and/or past the beam of thermal energy 475 (and, e.g., from a spool of the wire 472). In other embodiments, the thermal energy source 474 can alternatively or additionally be moved relative to the wire 472 to selectively heat the wire 472.

The substrate 471 can be a separate structure from the wire 472 that is subsequently removed, or can be a portion of the structure being fabricated by the system 470, such as a previously formed/deposited layer of the wire 472 (e.g., a lower layer where the structure is additively manufactured in the longitudinal direction). The thermal energy source 474 and/or the wire 472 can be moved relative to the substrate 471—and/or the substrate 471 can be moved relative to the thermal energy source 474 and/or the wire 472—according to a predefined geometry of the structure to be fabricated to additively build-up the structure. That is, the system 470 can deposit layers of the melted wire 472 in a stack-wise fashion to manufacture the structure. In some embodiments, the system 470 can be configured to supply a gas (e.g., an inert gas) toward the wire 472 to control various parameters of the manufacturing process. In some embodiments, the system can be one of any of the metal 3D printers manufactured by AddiTec Inc. of Las Vegas Nev.

Referring to FIGS. 3 and 4 together, beginning at block 361, the method 360 can include obtaining and/or forming the wire 472 of ODS material. In some embodiments, the ODS material can comprise molybdenum-lanthanum oxide and/or tungsten-lanthanum oxide. For example, the wire 472 can be of any of the molybdenum-lanthanum oxide and/or tungsten-lanthanum oxide types manufactured by Elmet Technologies LLC of Lewiston, Me. Such wires are typically used as high-temperature heating wires in electrical heating elements, such as are used for furnaces, and thus are available for purchase at a reasonable cost. Many other ODS materials are not commercially available in wire form. In some embodiments, the block 361 of the method 360 can include forming the wire 472 of ODS material via an ODS material fabrication process. Such a fabrication process can include ball milling a metal powder (e.g., a molybdenum-lanthanum or tungsten-lanthanum powder) and an oxide powder then compacting (e.g., pressing) the powders into an ingot or similar shape using a powder metallurgy process, such as a hot isostatic pressing (HIP) process. The compacted material can then be cold worked or hot worked to give the material a fine-grained structure with increased creep resistance. Finally, the ODS material can be drawn into a wire form using a cold pressing or other processes that preserve the ODS matrix structure.

At block 362, the method 360 can include directing the beam of thermal energy 475 toward the wire 472 from the thermal energy source 474 to heat and melt the wire 472 while moving the wire 472 relative to the thermal energy source 474 and/or moving the thermal energy source 474 relative to the wire 472. For example, the thermal energy source 474 can sequentially heat and melt the wire 472 as the feed mechanism 476 advances the wire 472 past the beam of thermal energy 475—thereby sequentially forming a weld pool 473 along the wire 472. In some embodiments, the wire 472 can be preheated.

At block 363, the method 360 can include depositing the melted wire 472 (e.g., the weld pool 473) on the substrate 471 according to the desired geometry of the structure to be fabricated. For example, the thermal energy source 474 and the wire 472 can be moved relative to the substrate 471 to selectively deposit a pattern (e.g., a layer) of the melted wire 472 corresponding to a shape/geometry of the desired structure.

At block 364, the method 360 can include cooling the melted wire 472 (e.g., the weld pool 473) such that an oxide of the ODS material remains substantially dispersed (e.g., in solution) within a metal matrix of the ODS material. The weld pool 473 cools and solidifies to form a portion 477 of the structure to be fabricated. In some aspects of the present technology, the cooling of the melted wire 472 can preserve the microstructures of the ODS material, thereby preserving the material properties of the ODS material including, for example, a good creep resistance, wear-resistance, and/or corrosion resistance at elevated temperatures.

More specifically, with continued reference to FIGS. 3 and 4 together, the system 470 can heat (block 362) only a small portion (e.g., volume) of the wire 472 at any given time. That is, the weld pool 473 can be relatively small such that the weld pool 473 can rapidly cool and solidify without extending to areas where the wire 472 has already been melted. In some aspects of the present technology, this can ensure that the oxide particles of the ODS material do not come out of solution of the metal matrix of the ODS material and remain dispersed within the metal matrix. In some embodiments, the size of the wire 472 and/or the power of the thermal energy source 474 can be selected to ensure that the oxide particles of the ODS material do not come out of solution of the metal matrix. As noted above, this can preserve the microstructures of the ODS material, thereby preserving the material properties of the ODS material. In contrast, a typical heat-shaping (e.g., hot pressing, hot working) or welding process using the wire 472 of ODS material would melt a large amount of the ODS material such that the melted material cools more slowly, causing the oxide material to come out of solution (e.g., not remain dispersed) of the metal material. Thus, such conventional fabrication processes can degrade/destroy some or all of the microstructures that are formed during the fabrication of the ODS material, thereby degrading the material properties of the final manufactured structure.

Accordingly, the method 360 allows for the fabrication of structures having complex geometries while still preserving the advantageous material properties of the ODS material. FIG. 5, for example, is an isometric view of a representative part or structure 580 that can be fabricated using the method 360 in accordance with embodiments of the present technology. In some embodiments, the structure 580 can be a heat exchanger usable in either of the nuclear reactor systems 100 or 200 described in detail above with reference to FIGS. 1 and 2.

Referring to FIG. 5, the structure 580 has been fabricated to have an integral/monolithic body 582 including/defining a plurality of first channels 584 and a plurality of second channels 586. In the illustrated embodiment, the body 582 has a generally rectilinear shape including a pair of opposing first faces or sides 583 and a pair of opposing second faces or sides 585. The first channels 584 can extend at least partially between the first sides 583 (e.g., along a first axis X) and the second channels 586 can extend at least partially between the second sides 585 (e.g., along a second axis y). In some embodiments, the first channels 584 can be distributed vertically along the body 582 (e.g., along a third axis Z) in first groups 587 (e.g., five of the first groups 587) each including two adjacent first channels 584. Similarly, the second channels 586 can be distributed vertically along the body 582 (e.g., along the axis Z) in second groups 589 (e.g., four of the second groups 589) each including a plurality of the second channels 586, such as multiple rows (e.g., three rows) and/or columns (e.g., thirteen columns) of the second channels 586. In some embodiments, the second groups 589 can be vertically interleaved between adjacent ones of the first groups 587. In the illustrated embodiment, the first and second channels 584, 586 have a generally rectangular cross-sectional shape while, in other embodiments, the first and second channels 584, 586 can have a circular, square, polygonal, irregular, or other cross-sectional shape.

In some embodiments, the first channels 584 can be heat pipes that include/define one or more wicks (not shown) and that contain a working fluid (not shown) therein. The working fluid can be a two-phase (e.g., liquid and vapor phase) material such as, for example, lithium, sodium, and/or potassium. The wicks can help move the working fluid against a pressure differential in the first channels 584. In some embodiments, as described in detail above with respect to FIG. 2 for example, the heat pipes 584 can be used to convey heat in a nuclear reactor system, such as from a reactor core. In some embodiments, the second channels 586 can contain a secondary working fluid and can be fluidly coupled to a power conversion system (e.g. the power conversion system 140 shown in FIG. 1) configured to generate electrical power, and/or to provide other useful outputs. The second channels 586 can absorb heat deposited from the first channels 584 and convey the heat to the power conversion system.

Referring to FIGS. 3-5 together, in some embodiments the structure 580 can be formed by additively building up the body 582 by sequentially melting the wire 472 using the additive manufacturing system 470. Accordingly, as described in detail above, in some aspects of the present technology the structure 580 can be fabricated from an ODS material (e.g., molybdenum-lanthanum oxide) without degrading the microstructures of the material. Therefore, the structure 580 can exhibit good corrosion resistance, mechanical properties, creep resistance, and/other ODS material properties at high temperature—such as during operation of a nuclear reactor system including the structure 580. In contrast, it would not be possible to manufacture the structure 580 using conventional ODS material fabrication techniques without degrading the ODS material properties of the structure. In particular, ODS materials cannot be easily cast or welded without substantially heating the material after forming the microstructures that give the ODS material the unique properties of increased corrosion resistance, creep resistance, among others. However, heating the ODS material in this manner degrades the microstructures and the mechanical properties as the oxide material of the ODS material comes out of solution from the metal material during the cooling/solidifying process. Accordingly, conventional methods are limited in the geometries that can be fabricated while retaining the ODS material properties.

In other embodiments, the method 360 and the system 470 can be used to fabricate other structures having complex geometries other than the structure 580. Indeed, one of ordinary skill in the art will understand that the method 360 and the system 470 can be used to fabricate structures having many geometries, including one or more of the components of the nuclear reactor systems 100 and/or 200 described in detail with respect to FIGS. 1 and 2.

The following examples are illustrative of several embodiments of the present technology:
1. A method of fabricating a monolithic structure, the method comprising:
repeatedly, and in a stack-wise fashion—
   directing a beam of thermal energy toward a wire formed of an oxide dispersion strengthened (ODS) material to melt the wire;
   depositing the melted wire on a substrate to form a layer of the structure; and
   permitting the melted wire to cool and solidify on the substrate.
2. The method of example 1 wherein the ODS material includes an oxide material dispersed within a metal material, and wherein permitting the melted wire to cool and solidify includes preventing the oxide material from coming out of solution from the metal material.
3. The method of example 1 or example 2 wherein the ODS material includes an oxide material dispersed within a metal material, and wherein permitting the melted wire to cool and solidify includes permitting the melted wire to cool and solidify while the oxide material remains substantially dispersed within the metal material.
4. The method of any one of examples 1-3 wherein the ODS material is molybdenum-lanthanum oxide.
5. The method of any one of examples 1-3 wherein the ODS material is tungsten-lanthanum oxide.
6. The method of any one of examples 1-5 wherein the monolithic structure is a part for a nuclear reactor system.
7. The method of any one of examples 1-6 wherein the method further comprises feeding the wire past the beam of thermal energy to selectively melt the wire.
8. The method of any one of examples 1-7 wherein the method further comprises moving the beam of thermal energy and the wire relative to the substrate to deposit the melted wire on the substrate according to the geometry of the structure.
9. The method of any one of examples 1-8 wherein the beam of thermal energy is a laser beam.
10. A monolithic structure formed according to the method of any one of examples 1-9.
11. A monolithic structure formed according to a method, comprising:
repeatedly, and in a stack-wise fashion—
   directing a beam of thermal energy toward a wire formed of an oxide dispersion strengthened (ODS) material to melt the wire;
   depositing the melted wire on a substrate to form a layer of the structure; and
   permitting the melted wire to cool and solidify on the substrate.
12. The monolithic structure of example 11 wherein the structure is a heat exchanger,
13. The monolithic structure of example 12 wherein the heat exchanger includes a plurality of first channels extending in a first direction and a plurality of second channels extending in a second direction.
14. The system of any one of examples 11-13 wherein the monolithic structure is a part for a nuclear reactor system.
15. The monolithic structure of any one of examples 11-14 wherein the ODS material is molybdenum-lanthanum oxide.
16. The monolithic structure of any one of examples 11-14 wherein the ODS material is tungsten-lanthanum oxide.
17. The monolithic structure of any one of examples 11-16 wherein the ODS material includes an oxide material substantially dispersed within a metal material.
18. A method of fabricating a part for a nuclear reactor system, the method comprising:
directing a beam of thermal energy toward a wire formed of an oxide dispersion strengthened (ODS) material to melt the wire, wherein the ODS material includes an oxide material dispersed within a metal material; and
permitting the melted wire to cool and solidify to form the part such that the oxide material remains substantially dispersed within the metal material.
19. The method of example 18 wherein the part is a heat exchanger.
20. The method of example 18 or example 19 wherein the metal material is molybdenum-lanthanum.
21. A system for fabricating a monolithic structure, comprising:
a wire formed of an oxide dispersion strengthened (ODS) material;
a thermal energy source positioned to direct a beam of thermal energy toward the wire to melt the wire; and
a substrate positioned to receive the melted wire, wherein the substrate and thermal energy source are configured to move relative to one another such that the melted wire is deposited on the substrate according to a geometry of the structure.
22. The system of example 21 wherein the ODS material is molybdenum-lanthanum oxide.
23. The system of example 21 wherein the ODS material is tungsten-lanthanum oxide.
24. The system of any one of examples 21-23 wherein the monolithic structure is a part for a nuclear reactor system.
25. The system of any one of examples 21-24 wherein the thermal energy source is a laser source, and wherein the beam of thermal energy is a laser beam.
26. The system of any one of examples 21-25 wherein the thermal energy source is movable relative to the substrate.
27. The system of any one of examples 21-26 wherein the ODS material includes an oxide material dispersed within a metal material, and wherein the beam of thermal energy is configured to melt the wire such that the melted wire cools and solidifies on the substrate without the oxide material coming out of solution from the metal material.
28. The system of any one of examples 21-27 wherein the ODS material includes an oxide material dispersed within a metal material, and wherein the beam of thermal energy is configured to melt the wire such that the melted wire cools and solidifies on the substrate while the oxide material remains substantially dispersed within the metal material.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology as those skilled in the relevant art will recognize. For example, although steps are presented in a given order, other embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. To the extent any materials incorporated herein by reference conflict with the present disclosure, the present disclosure controls. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of fabricating a monolithic structure, the method comprising:
repeatedly, and in a stack-wise fashion—
directing a beam of thermal energy toward a wire formed of an oxide dispersion strengthened (ODS) material to melt the wire;
depositing the melted wire on a substrate to form a layer of the structure; and
permitting the melted wire to cool and solidify on the substrate.

2. The method of claim 1 wherein the ODS material includes an oxide material dispersed within a metal material, and wherein permitting the melted wire to cool and solidify includes preventing the oxide material from coming out of solution from the metal material.

3. The method of claim 1 wherein the ODS material includes an oxide material dispersed within a metal material, and wherein permitting the melted wire to cool and solidify includes permitting the melted wire to cool and solidify while the oxide material remains substantially dispersed within the metal material.

4. The method of claim 1 wherein the ODS material is molybdenum-lanthanum oxide.

5. The method of claim 1 wherein the ODS material is tungsten-lanthanum oxide.

6. The method of claim 1 wherein the monolithic structure is a part for a nuclear reactor system.

7. The method of claim 1 wherein the method further comprises feeding the wire past the beam of thermal energy to selectively melt the wire.

8. The method of claim 1 wherein the method further comprises moving the beam of thermal energy and the wire relative to the substrate to deposit the melted wire on the substrate according to the geometry of the structure.

9. The method of claim 1 wherein the beam of thermal energy is a laser beam.

10. A monolithic structure formed according to the method of claim 1.

11. A monolithic structure formed according to a method, comprising:
repeatedly, and in a stack-wise fashion—
directing a beam of thermal energy toward a wire formed of an oxide dispersion strengthened (ODS) material to melt the wire;
depositing the melted wire on a substrate to form a layer of the structure; and
permitting the melted wire to cool and solidify on the substrate.

12. The monolithic structure of claim 11 wherein the structure is a heat exchanger,

13. The monolithic structure of claim 12 wherein the heat exchanger includes a plurality of first channels extending in a first direction and a plurality of second channels extending in a second direction.

14. The system of claim 11 wherein the monolithic structure is a part for a nuclear reactor system.

15. The monolithic structure of claim 11 wherein the ODS material is molybdenum-lanthanum oxide.

16. The monolithic structure of claim 11 wherein the ODS material is tungsten-lanthanum oxide.

17. The monolithic structure of claim 11 wherein the ODS material includes an oxide material substantially dispersed within a metal material.

18. A method of fabricating a part for a nuclear reactor system, the method comprising:
directing a beam of thermal energy toward a wire formed of an oxide dispersion strengthened (ODS) material to melt the wire, wherein the ODS material includes an oxide material dispersed within a metal material; and
permitting the melted wire to cool and solidify to form the part such that the oxide material remains substantially dispersed within the metal material.

19. The method of claim 18 wherein the part is a heat exchanger.

20. The method of claim 18 wherein the metal material is molybdenum-lanthanum.
